(19) United States
(12) Patent Application Publication
(10) Pub. No.: US 2026/0281516 A1
(43) Pub. Date: Sep. 17, 2026

(54) SYSTEMS AND METHODS FOR DYNAMICALLY ADJUSTING MULTIMEDIA CONTENT

(71) Applicant: Warner Bros. Discovery, Inc., New York, NY (US)

(72) Inventor: Lakshmi NRUSIMHAN, Bangalore (IN)

(21) Appl. No.: 19/190,995

(22) Filed: Apr. 28, 2025

(30) Foreign Application Priority Data
Mar. 13, 2025 (IN) 202511022636

(51) Int. Cl. H04N 21/854; H04N 21/442

(52) U.S. Cl. CPC H04N 21/854; H04N 21/44218

(57) ABSTRACT

Systems and methods for dynamically adjusting multimedia content are disclosed. One computer-implemented method may include: receiving, at a computer system, data associated with a currently playing multimedia article; identifying, using a processor associated with the computer system to analyze the data, audience sentiment toward the currently playing multimedia article; adjusting, using the processor, at least one aspect of the currently playing multimedia article based on the identified audience sentiment; and presenting the adjusted at least one aspect in the currently playing multimedia article.

### CROSS-REFERENCE TO RELATED APPLICATION(S)

This application claims the benefit of priority to Indian Patent Application No. 202511022636, filed on Mar. 13, 2025, the entirety of which is incorporated herein by reference.

### TECHNICAL FIELD

Various embodiments of the present disclosure relate generally to the field of entertainment media, and, more particularly, to systems and methods for generating and rendering dynamic multimedia content by adapting media characteristics based on audience feedback and/or environmental factors.

### BACKGROUND

Traditional movie production involves a predefined script, characters, scenes, and soundtracks, which are typically the same for all audiences of the content. Such an approach does not necessarily consider the audience's real-time emotional engagement or the environmental settings in which the content is being consumed. Consequently, the experience can be consistent but may also lack the benefit of additional customization and personalization. Accordingly, a need exists for a system that may dynamically generate and alter movie content based on real-time feedback based on the audience's inputs, psychological indicators, and/or the audience's ambient environment.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for dynamically adjusting aspects of multimedia content based on audience sentiment.

In one aspect, a computer-implemented method is disclosed. The computer-implemented method may include: receiving, at a computer system, data associated with a currently playing multimedia article; identifying, using a processor associated with the computer system to analyze the data, audience sentiment toward the currently playing multimedia article; adjusting, using the processor, at least one aspect of the currently playing multimedia article based on the identified audience sentiment; and presenting the adjusted at least one aspect in the currently playing multimedia article.

In another aspect, a system is disclosed. The system may include: a memory including instructions; and at least one processor configured to execute the instructions stored in the memory to perform operations comprising: receiving data associated with a currently playing multimedia article; identifying, based on analysis of the data, audience sentiment toward the currently playing multimedia article; adjusting at least one aspect of the currently playing multimedia article based on the identified audience sentiment; and presenting the adjusted at least one aspect in the currently playing multimedia article.

In yet another aspect, a non-transitory computer-readable medium storing computer-executable instructions is disclosed. The non-transitory computer-readable medium, when executed by a server in network communication with at least one database, may cause the server to perform operations including: receiving, at a computer system, data associated with a currently playing multimedia article; identifying, using a processor associated with the computer system to analyze the data, audience sentiment toward the currently playing multimedia article; adjusting, using the processor, at least one aspect of the currently playing multimedia article based on the identified audience sentiment; and presenting the adjusted at least one aspect in the currently playing multimedia article.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts components of an exemplary system configured to perform dynamic multimedia content adjustments, according to one or more embodiments of the present disclosure.

FIG. 2 depicts a sequence diagram that illustrates the dynamic interaction process among various component of the exemplary system in FIG. 1, according to one or more embodiments of the present disclosure.

FIG. 3 depicts an exemplary process flow for facilitating dynamic multimedia content adjustments, according to one or more embodiments of the present disclosure.

FIG. 4 depicts an example computing system, according to one or more embodiments of the present disclosure

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “user”, “subscriber,” and the like generally encompasses consumers who are subscribed to a streaming service (e.g., streaming platform) associated with the system described herein. The term “streaming service” (e.g., streaming platform) may refer to subscription-based video-on-demand (SVoD) services such as television shows, films, documentaries, and the like. The term “user” may be used interchangeably with “user profile,” “profile,” and the like throughout this application. The phrase “registered with” may be used interchangeably with “subscribed to” and the like throughout this application. The phrase “multimedia content” may be used interchangeably with “multimedia content item,” “article of multimedia content,” and the like throughout this application.

The field of multimedia entertainment, particularly movies and TV series, has traditionally focused on delivering content in a static, one-size-fits-all format. This approach can lack adaptability to the specific, real-time responses of the audience, leading to an experience that may feel insufficiently engaging or personal for viewers. In standard movie production, content elements such as storylines, dialogue, characters, and audiovisual cues may be created in advance and remain unchanged, regardless of the audience's mood, engagement level, or viewing environment. This conventional approach can potentially fail to capture the dynamic nature of individual audience preferences and engagement, which may vary widely across different viewers and viewing environments. As a result, the traditional model does not necessarily fully optimize the immersive potential of storytelling and can potentially fall short of creating a completely impactful, personalized experience.

Attempts have been made to introduce personalization in various forms, such as interactive storytelling and choose-your-own-adventure formats, where viewers make discrete choices at branching points to influence the storyline. However, these methods still offer a limited degree of interactivity, as the available choices are predefined and provide only minimal customization, without real-time adaptation to the audience's ongoing emotional state. These conventional approaches remain linear at their core and do not account for subtler, continuous variations in the audience's psychological responses or the viewing environment. Consequently, these systems are often incapable of sustaining audience engagement over time, as the storyline lacks fluid responsiveness to individual viewers' evolving emotions and immediate surroundings.

To address the above-noted challenges, the present disclosure contemplates a system that may be configured to provide a comprehensive solution by enabling the real-time generation and adaptation of movie content based on continuous feedback from both the audience's psychological cues and environmental settings. This dynamic approach addresses the limitations of conventional models by creating a feedback loop that periodically or continuously informs content generation engines, allowing the storyline, characters, script, and ambience to evolve responsively. This system may include several interconnected engines, e.g., an audience ambience listener (AAL) that gathers data on the audience's emotional state and environment, a content generator services that processes this data, and a suite of creation engines, e.g., a story creation engine, a script creation engine, a character creation engine, and a dialogue creation engine, which collectively build and adjust the movie's narrative in real time.

The dynamic system described herein offers a transformative viewing experience by tailoring content to each audience's unique engagement level and psychological profile. Unlike prior approaches, the disclosed system does not rely on static or predefined paths but instead generates content elements that adapt organically based on continuous feedback. For example, the story's pace and mood may shift dynamically to retain viewer engagement if the system detects waning interest or changing ambient conditions. Characters may display more empathetic behavior or take on new traits that align with audience emotions, making them more relatable and intensifying the viewer's connection with the story. Dialogue and scene-rendering elements may likewise be adapted, creating an immersive experience where each viewing is as unique as the audience's real-time feedback.

The concepts described herein not only resolve issues associated with static storytelling, but also offer a scalable framework for future content creation. By analyzing patterns in audience responses, this system may provide valuable insights that may inform content development for various audiences, refining the approach to align better with diverse psychological profiles and preferences. This capability enables a new level of audience interaction and emotional connection, creating experiences that resonate deeply and improve engagement. The system's adaptability, real-time feedback mechanism, and ability to tailor content based on audience psyche and environment represent a significant advancement in the field of interactive and immersive media entertainment.

The systems and methods described herein represent a variety of technical improvements to the technical field of multimedia and content generation systems. The novel system introduces a dynamic, real-time adaptation mechanism that leverages advanced computing processes to interactively adjust storytelling elements, creating a unique viewing experience. Through the processes described herein, content elements such as the narratives, characters, and sound may be modified based on rea-time feedback gathered from the audience and environment, which marks a leap forward in the evolution of immersive and adaptive digital experiences. Additionally, this system leverages advancements in artificial intelligence, sensory feedback analysis, and real-time processing to create a content generation model that may continuously assess and respond to audience sentiment. This responsiveness improves the technical field of content creation, allowing for applications in adaptive learning, personalized entertainment, and even therapeutic environments where audience engagement and mood are important.

Although the subject matter disclosed herein is generally described with reference to film or cinema, such a designation is not limiting. More particularly, the system described herein may be broadly applicable to a variety of other media types, including video games, interactive simulations, virtual and augmented reality experiences, educational content, and live performance streaming. For instance, in video games, the system may dynamically adjust the storyline, character interactions, and background music based on the player's in-game decisions, emotional engagement, and even physical environment. In VR/AR settings, the system may alter the scene rendering, ambient sounds, and interaction patterns based on real-time feedback from the user's physical and emotional states, thereby creating more responsive and realistic experiences. In educational media, the technology may be used to tailor content delivery to match the student's attention level and comprehension, modifying lesson pacing, presentation styles, or supportive narration to enhance learning outcomes. Live performance streaming services may also leverage these novel concepts to alter camera angles, sound levels, and other elements to reflect the audience's reactions or engagement levels, creating a more personalized viewing experience.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

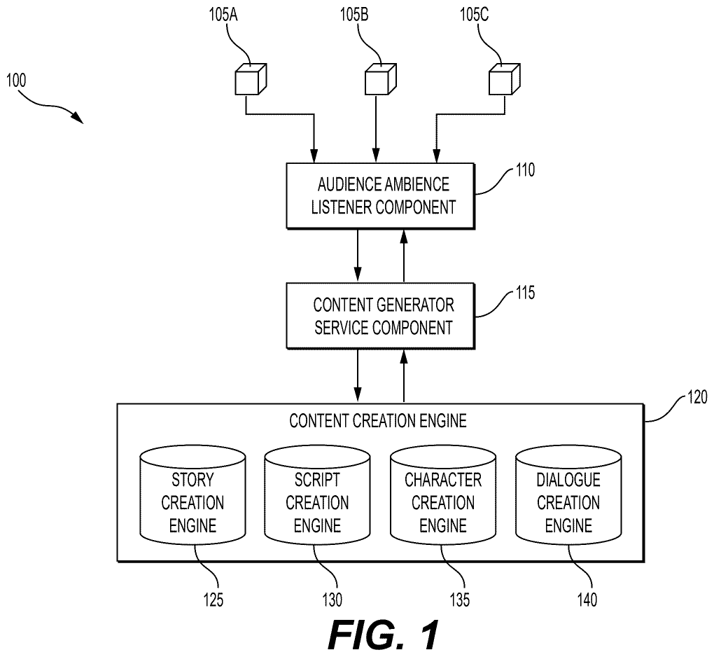

FIG. 1 depicts components of an exemplary system 100 that may be configured to perform dynamic adjustments to multimedia content. In an aspect, the components encompassed by the system 100 may include each of: one or more sensors 105(A-C), an audience ambience listener (AAL) component 110, content generator service component 115, content creation engine 120, story creation engine 125, script creation engine 130, character creation engine 135, and dialogue creation engine 140. Although each of the foregoing components is included in FIG. 1, in other aspects, a subset of the foregoing components may be utilized.

In an aspect, the AAL component 110 may be configured to continuously capture and interpret real-time data on the audience's reactions and the surrounding environment to drive dynamic content adaptations. The primary purpose of the AAL component 110 may be to act as an intelligent sensory interface that monitors the emotional and physical ambience of the audience, including indicators such as sound levels, facial expressions, body language, and even physiological cues such as heart rate, gaze detection, etc., if the relevant sensors are present. In an aspect, the AAL component 110 may additionally be configured to register environmental factors such as lighting, temperature, and sound quality within the viewing space, creating a holistic understanding of both the audience's internal and external experiences.

In an aspect, the AAL component 110 may collect data through a combination of audio, visual, and/or environmental sensors (e.g., sensors 105(A-C)), feeding it to a content generator service component 115 for interpretation and response. For instance, if the AAL component 110 detects elevated sound levels like laughter, cheers, or gasps, it may signal high engagement or emotional peaks, prompting the system to enhance these moments by adjusting the pacing, music, or lighting to align with the audience excitement. In quieter or more suspenseful scenes, the AAL component 110 may detect subtle body language cues such as leaning forward, allowing the system to intensify suspense through soundscapes or visual effects. By continuously assessing both direct audience reactions and indirect environmental cues, the AAL component 110 is able to provide a responsive content experience that mirrors the audience's mood and adapts fluidly as the viewing progresses.

In an aspect, the content generator service component 115 may act as the core processing unit within the system, orchestrating the real-time adaptation of the narrative based on inputs from the AAL component 110. The content generator service component 115 may be configured to dynamically generate, coordinate, and modulate the elements of the story, such as plot structure, pacing, dialogue, character behavior, and environmental effects, in response to audience feedback and/or ambient data. Acting as the intermediary between the sensory data captured by the AAL component 110 and one or more creative engines responsible for producing content components, the content generator service component 115 is where raw data is transformed into actionable storytelling adjustments. When the content generator service component 115 receives data from the AAL component 110 indicating specific audience reactions, it may translate this information into a set of commands or adjustments, which may then be passed to the content creation engine 120 for execution.

In some implementations, the system 100 may use past audience data to load a set of possible storylines, characters, scenes, and dialogues, e.g., organized like branches on a decision tree. As the movie plays, input from the AAL component 110 may be received at the content generator service component 115 (e.g., real-time audience reactions, such as sounds, facial expressions, and environmental conditions). The content generator service component 115 may then process this data to generate a score (e.g., an “A Factor”), which may reflect the audience's current emotional state and overall vibe. This A Factor may be used to select the most fitting path from the preloaded story options. If the A Factor doesn't match any existing path, it means that the audience is reacting in a new or unexpected way—so the system 100 may adapt by creating a new storyline on the fly, changing elements like the plot, characters, or music to better align with the audience's mood, all without interrupting playback.

In an aspect, the content creation engine 120 may act as the execution layer within the system 100, responsible for generating and delivering the actual narrative elements, such as scenes, dialogues, character actions, and visual effects, which adapt in response to the audience's engagement and ambient factors. In this regard, the content creation engine 120 may be configured to take directives from the content generator service component 115 and translate them into real-time changes within the content, thereby ensuring that the story flows dynamically and remains aligned with the audience's collective mood, reactions, and the overall viewing atmosphere. Acting as the hub for the various creation engines (e.g., such as the story creation engine 125, the script creation engine 130, the character creation engine 135, and the dialogue creation engine 140), the content creation engine 120 organizes these components into a cohesive, adaptive storytelling experience that reacts organically to audience and environmental cues.

As an example of the foregoing, if the content generator service component 115 detects high levels of audience excitement or suspense, it may instruct the content creation engine 120 to intensify specific aspects of the narrative by requesting a more dramatic scene outline from the story creation engine 125, or by accelerating dialogue and actions from the script creation engine 130 and the character creation engine 135. Similarly, if the content generator service component 115 identifies a calmer or more reflective audience mood, it may instruct the content creation engine 120 to create slower-paced scenes or add contemplative musical scores, enhancing immersion for the audience.

In an aspect, the content creation engine's 120 role as an integrator means that it also manages the synchronization and timing of various elements so that each modification flows seamlessly within the existing narrative. This may involve coordinating character interactions with plot developments or ensuring that background music, sound effects, and lighting changes align precisely with the unfolding scene. The ability of the content creation engine 120 to integrate input from multiple creation services enables it to craft a consistent and harmonious viewing experience, even as individual elements are modified in real-time.

In an aspect, the story creation engine 125 may be a component that is part of the system 100 responsible for generating and modifying the core narrative structure in response to real-time audience feedback and/or environmental cues. The story creation engine 125 may be configured to provide a flexible, dynamic storyline that may be shaped and reshaped based on the audience's reactions, ensuring that the plot remains engaging, relevant, and emotionally resonant throughout the viewing experience. Unlike traditional linear storytelling, where plot points and character arcs are fixed, the story creation engine 125 may operate with a modular narrative framework, allowing it to introduce new scenes, adjust pacing, or pivot plot directions in response to data received from the content generator service component 115.

In an aspect, the script creation engine 130 may be a component that is part of the system 100 responsible for generating and adjusting the dialogue and narrative text that drive character interactions and scene progression. The script creation engine 130 may be configured to ensure that the script—comprising dialogues, monologues, and scene descriptions—adapts fluidly in response to real-time audience feedback, enhancing the narrative's impact and emotional resonance. While traditional scripts may be static and predetermined, the script creation engine 130 operates with flexibility, allowing it to modify language, tone, and even the thematic focus of dialogue to reflect the audience's collective mood and engagement levels as captured by the AAL component 110. This adaptability enables the script to evolve in alignment with the unfolding story, helping to maintain a natural flow and resonance with the audience's reactions, emotions, and the environment.

The script creation engine 130 may work in coordination with data received from the content generator service component 115, which provides cues based on audience data processed from the AAL component 110. For instance, if the content generator service component 115 detects heightened excitement or humor among the audience, it may instruct the script creation engine 130 to introduce lighter, more comedic dialogue, amplifying the humor to enhance audience enjoyment. Conversely, if the audience is observed to be particularly engaged with dramatic or emotional elements, the script creation engine 130 may adjust the dialogue to be more poignant, introspective, or intense, thereby deepening the emotional impact of the scene. These real-time modifications may ensure that each line spoken by the characters aligns with the audience's emotional state, making the story feel responsive and alive.

In an aspect, the character creation engine 135 may be a component that is part of the system 100 responsible for bringing stories to life by dynamically shaping the characters' appearances, behaviors, and interactions in response to real-time audience reactions and storyline developments. The character creation engine 135 may be configured to ensure that each character remains emotionally engaging and believable, with adaptive traits that respond fluidly to shifts in the narrative and the audience's mood. Unlike traditional character models that are fixed and consistent across all scenes, characters generated by the character creation engine 135 may exhibit evolving expressions, personalities, and actions that enhance their connection to the audience. This adaptability allows characters to feel more alive and responsive to the story's direction and the audience's engagement, creating an immersive experience where viewers feel personally invested in the characters' journeys.

Functionally, the character creation engine 135 may interface with both the content generator service component 1155 and the story and script creation engines 125, 130 to ensure that character traits align with real-time adjustments in plot and dialogue. For example, if the story creation engine 125 introduces a dramatic plot twist or an emotional moment, the character creation engine 135 may adjust characters' facial expressions, body language, and tone of voice to convey the depth of these development authentically. Similarly, if the audience responds positively to humorous or lighthearted scenes, the character creation engine 135 may make characters more animated, expressive, or playful, reinforcing the comedic atmosphere and enhancing audience enjoyment. In an aspect, the character creation engine 135 may also tailor each character's behavior based on specific audience cues. For instance, if the ALL component 110 detects a high level of empathy or emotional connection with the audience, the character creation engine 135 may deepen character expressions and interactions, allowing for more nuanced and relatable behavior that aligns with the audience's emotional engagement.

In an aspect, the dialogue creation engine 140 may be a component that is part of the system 100 responsible for generating and adjusting spoken elements—such as character dialogue, monologues, and vocal interactions—in response to real-time audience feedback and evolving narrative demands. The dialogue creation engine 140 may be configured to ensure that the dialogue remains authentic, emotionally engaging, and perfectly suited to the scene's tone and the audience's mood, amplifying the immersive quality of the story. Unlike traditional pre-written scripts, the dialogue creation engine 140 may enable dialogue to be fluid and responsive, allowing it to adapt in real-time to the emotional state of the audience and any narrative shifts directed by the content generator service component 115. By crafting dialogue that resonates with the viewer's reactions and the storyline's dynamic arc, the dialogue creation engine 140 may help characters communicate in ways that feel fresh, relatable, and attuned to the unfolding plot.

Functionally, the dialogue creation engine 140 may work with the content generator service component 115 and other creation engines (e.g., the script and character creation engines 130, 135) to seamlessly integrate adaptive language into each scene. More particularly, when the content generator service component 115 detects a shift in audience engagement—such as increased laughter, suspense, or empathy—the dialogue creation engine 140 may modify the tone, pacing, and content of the dialogue to mirror these emotional cues. For instance, if the audience reacts with laughter or amusement, the dialogue creation engine 140 may introduce more witty lines, banter, or lighthearted exchanges, enhancing the comedic effect. Conversely, if the audience displays emotional engagement, such as through silence, leaning in, or subtle body language cues, the dialogue creation engine 140 may infuse the dialogue with a more serious or heartfelt tone, intensifying the impact of an emotional scene. In an aspect, the dialogue creation engine 140 may also adapt dialogue in response to storyline changes and character developments dictated by the story and character creation engines 125, 135. For example, if a new plot twist occurs or a character's role evolves, the dialogue creation engine 140 may generate dialogue that reflects the new context, ensuring continuity and believability. As another example, if a character becomes more introspective or conflicted as a result of plot developments, the dialogue creation engine 140 may adjust the character's spoken expressions to match this growth, perhaps by using more introspective or conflicted language, aligning seamlessly with the character's evolving arc.

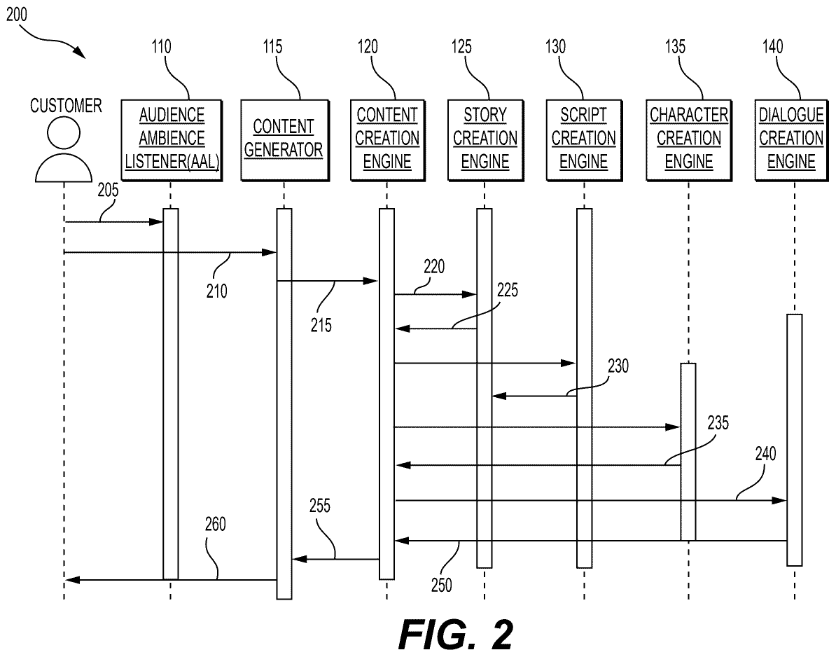

Referring now to FIG. 2, a sequence diagram 200 is presented that illustrates the dynamic interaction process among various components in the system 100. In an aspect, the sequence workflow may begin, at step 205, with the AAL component 110 observing both the audience's reactions and the environmental ambiance. This ongoing observation provides the system with real-time feedback about audience engagement, mood, and external factors (e.g. such as lighting and sound levels), which may impact the viewing experience. In an aspect, once the AAL component 110 has collected sufficient data (e.g., once the AAL component 110 has collected any data, once the AAL component 110 has collected a predetermined amount of data, once the AAL component 110 has collected data over a predetermined period of time, etc.), it may, at step 210, transmit this information to the content generator service component 115. This transmission package may include key indicators of the audience's emotional state and the environmental conditions. In response, the content generator service component 115 may initiate the content generation process by interacting, at step 215, with the content creation engine 120, which is responsible for orchestrating and coordinating the various content elements based on the incoming audience feedback.

In an aspect, the content creation engine 120 may, in one exemplary scenario, request, at step 220, a narrative outline from the story creation engine 125. The story creation engine 125 utilizes the audience data to create an adaptable storyline that reflects the audience's mood, such as by intensifying suspense or adjusting pacing, and returns, at step 225, this “outline story” to the content creation engine 120. Following this, the content creation engine 120 may request, at step 230, a tailored script from the script creation engine 130, which may be configured to craft dialogue and monologues that align with both the plot and the detected audience responses. The script creation engine 130 may then return, at step 230, the adjusted script to the story creation engine 125, completing this part of the dynamic adaptation.

Next, the content creation engine 120 may interact, at step 235, with the character creation engine 135 to receive characters that adapt in appearance, expressions, and behaviors based on the audience's emotional state. The character creation engine 135 may return, at step 240, these adaptive characters, further customizing the content to enhance the connection between the audience and the narrative. Following character adjustments, the content creation engine 120 may call at step 245, the dialogue creation engine 140 to generate specific dialogues that suit the mood and progression of the storyline. The dialogue creation engine 140 may produce real-time dialogues that reflect the emotional tone and engagement of the audience, and may transmit, at step 250, these back to the content creation engine 120.

Once all content elements (e.g., story, script, characters, and dialogues) have been generated and customized based on the audience data, the content creation engine 120 may consolidate them into a cohesive, adaptive narrative package. The content creation engine 120 may then return, at step 255, the final, dynamically created content to the content generator service component 115, which ensures that all elements are seamlessly integrated. Finally, the content generator service component 115 may initiate, at step 260, playback of this personalized content for the audience, allowing them to experience a version of the story that is uniquely tailored to their collective mood and reactions.

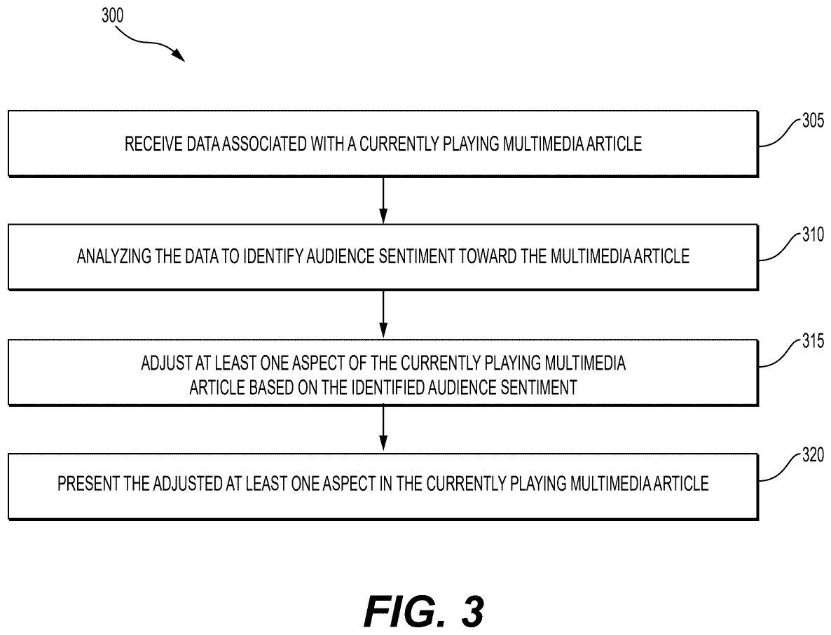

Referring now to FIG. 3, an exemplary process flow 300 for facilitating dynamic adjustments to multimedia content is provided, according to one or more embodiments of the present disclosure. Exemplary process flow 300 may be implemented by any combination of components included in system 100.

At step 305, data associated with a currently playing media article may be received at a first component (e.g., the AAL component 110) of the system 100. In an aspect, the first component may act as an input module responsible for collecting data related to the multimedia article that is currently being played. This data can include various forms of input such as audience feedback, environmental conditions (e.g., lighting, sound levels, etc.), or direct user interactions (e.g., play/pause actions, volume adjustments, etc.). The input may be gathered through one or more sensors (e.g., camera sensors, microphones, temperature sensors, etc.), user interface modules (e.g., remote control devices, smart phones, tablets, laptop or desktop computers, etc.), or other types of external monitoring systems. The data received may form the basis for any subsequent modifications made to the multimedia article.

At step 310, once data is received, an analysis may be performed to interpret and identify the sentiment of the audience. This analysis step may leverage algorithms, potentially involving learning models, to evaluate the collected data and detect patterns indicative of audience reactions. In this regard, the system may use emotion detection software capable of recognizing facial expressions, vocal intonations, and other behavioral cues to classify the audience's sentiment as positive, neutral, or negative. For instance, programs may be trained on historical data to identify specific audience responses and map these responses to sentiment categories. In the context of the underlying application, the components responsible for this processing and analysis may be any one or more of: the content generator service component 115, content creation engine 120, and/or any sub-engines 125-140 managed by the content creation engine 120. In an aspect, the transfer may occur through internal data buses, shared memory, or networked communication channels.

At step 315, at least one aspect of the currently playing multimedia article may be adjusted based on the identified audience sentiment. More particularly, a collection of system components may work together to change aspects of the multimedia content including, but not limited to, altering the story progression, adjusting visual effects, modifying audio characteristics (e.g., volume, background music, etc.), or changing character behavior or dialogue within the multimedia article. This process may involve complex decision-making algorithms or AI models that process the received data and determine the appropriate changes to make. This ensures that the multimedia article is responsive to real-time conditions or audience reactions. For example, if the audience's engagement level drops (e.g., as detected by one or more relevant sensors), the system 100 may dynamically enhance certain visual or audio effects to recapture attention.

At step 320, once adjustments are made, the modified aspect(s) of the multimedia article may be presented in real-time as the multimedia content continues to play. This ensures a seamless viewing experience where the changes are integrated without interrupting playback. The presentation may involve updating visual displays, altering audio output, or modifying any interactive elements associated with the multimedia article. This step ensures that the audience receives an updated version of the content, customized based on real-time data processing. The continuous presentation after adjustment maintains the immersive nature of the multimedia experience and demonstrates the system's ability to adapt dynamically.

In an aspect, in scenarios where the audience consists of a large group of people, the system may be capable of analyzing the collective emotional state of the crowd to guide content adjustments. Rather than tailoring responses to individual reactions, which may vary widely in larger audiences, the system may employ algorithms to detect and prioritize the most prevalent emotion within the group. For example, if a significant portion of the audience expresses excitement or laughter during a particular scene, the system may amplify this tone by introducing additional humor, increasing pacing, or adding upbeat music. Conversely, if the majority of viewers exhibit signs of suspense or heightened engagement, the system may prolong tense moments, adjusting lighting to be more dramatic, or deepen dialogue to enhance the intensity of the scene. This group-focused emotional analysis ensures that content adaptations are meaningful on a broader scale, effectively resonating with the largest portion of the audience. By prioritizing the dominant emotional cues, the system prevents jarring or conflicting adjustments that may occur if individual responses were treated independently in a large group setting.

In another embodiment, the system may be configured to selectively focus on the reactions of a specific subset of the audience, such as by demographic, behavioral, or preference-based criteria, while disregarding the reactions of other audience members. This tailored approach allows for highly specialized adjustments in the content, enabling more precise and targeted modifications. For example, in a family viewing environment, the system may prioritize the reactions of children, adjusting the content to make it more vibrant, humorous, or fantastical to align with the younger audience's preferences, while de-emphasizing adult reactions. Conversely, in screenings intended primarily for adults, the system may tune its adaptations based on the emotional cues of the adult audience members, shifting the tone to be more sophisticated or suspenseful based on their reactions, even if children are present. Other applications may involve focusing on gender-specific audience reactions to tailor content accordingly. For example, in an experimental film screening, the system may be configured to respond primarily to the reactions of women, adjusting the storyline or dialogue to reflect the themes or elements that resonate more with that demographic. Similarly, in a sports-themed film or live broadcast, the system may prioritize the responses of men if they are the target demographic, emphasizing action-oriented scenes, accelerating pacing, or enhancing crowd sounds in response to higher energy levels detected among that subset.

In an aspect, the system may be configured to generate and save a detailed record of the adjustments made throughout a movie or live experience adds a valuable dimension for analysis and future content refinement. This record may include data on each real-time adjustment triggered during the screening, such as changes in pacing, dialogue modifications, shifts in lighting, or variations in background music, etc., all of which may be based on audience reactions and/or environmental factors. By cataloging these dynamic changes, the system may create a comprehensive log that reflects the audience's emotional journey and engagement levels throughout the viewing experience. This record may then be saved and used to analyze audience preferences and reactions to specific scenes, providing a wealth of insights into what resonated most with viewers. In an aspect, the data may be shared, e.g., as a notification or report with an event organizer, filmmaker, or data analyst for immediate or post-event review. By receiving a summary or detailed account of all adjustments, organizers may assess the effectiveness of the adaptive system and gain a deeper understanding of audience behavior. For instance, a data analyst may examine the moments when engagement peaked and the types of adjustments that correlated with high audience excitement, laughter, or suspense, which may inform content creators on how to structure future scenes, identify audience preferences by demographic, and even refine storytelling techniques to better match real-time engagement trends. In an aspect, this reporting feature may also be valuable for feedback loops in iterative content developments. For instance, directors or producers who receive these adjustment records may compare responses across different screenings, allowing them to refine the adaptive algorithms and make content that is increasingly in tune with audience preferences.

In general, any process discussed in this disclosure that is understood to be computer-implementable, such as the processes illustrated in FIGS. 2 and 3, may be performed by one or more processors of a computer system, such as computer system 100 described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable type of processing unit.

A computer system, such as computer system 100, may include one or more computing devices. If the one or more processors of the computer systems are implemented as a plurality of processors, the plurality of processors may be included in a single computing device or distributed among a plurality of computing devices. If the computer system 100 comprises a plurality of computing devices, the memory of the computer system 100 may include the respective memory of each computing device of the plurality of computing devices.

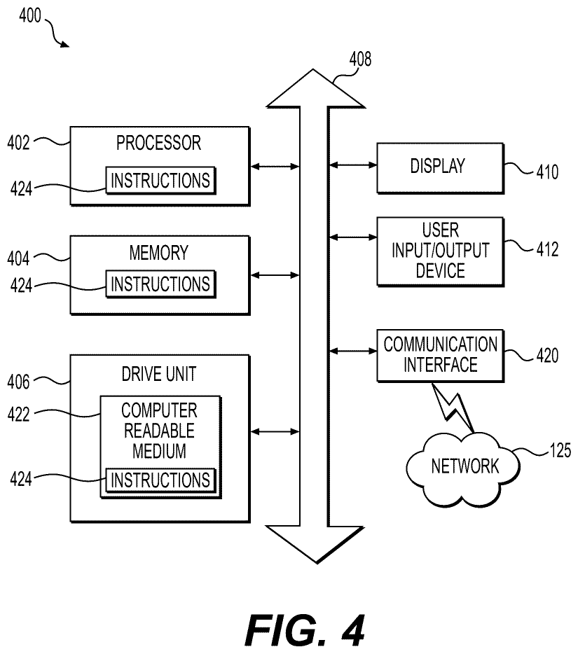

FIG. 4 is a simplified functional block diagram of a computer system 400 that may be configured as a computing device for executing the process illustrated in FIGS. 2 and 3, according to exemplary embodiments of the present disclosure. FIG. 4 is a simplified functional block diagram of a computer that may be configured as the computer system 100 according to exemplary embodiments of the present disclosure. In various embodiments, any of the systems herein may be an assembly of hardware including, for example, a data communication interface 420 for packet data communication. The platform also may include a central processing unit (“CPU”) or processor 402, in the form of one or more processors, for executing program instructions. The platform may include an internal communication bus 408, and a storage unit 406 (such as ROM, HDD, SDD, etc.) that may store data on a computer readable medium 422, although the system 400 may receive programming and data via network communications via electronic network 425 (e.g., voice, video, audio, images, or any other data over the electronic network 425). The system 400 may also have a memory 404 (such as RAM) storing instructions 424 for executing techniques presented herein, although the instructions 424 may be stored temporarily or permanently within other modules of system 400 (e.g., processor 402 and/or computer readable medium 422). The system 400 also may include input and output devices 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include but are not limited to: the process shown in FIG. 5, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method, the computer-implemented method comprising operations including:
receiving, at a computer system, data associated with a currently playing multimedia article;
identifying, using a processor associated with the computer system to analyze the data, audience sentiment toward the currently playing multimedia article;
adjusting, using the processor, at least one aspect of the currently playing multimedia article based on the identified audience sentiment; and
presenting the adjusted at least one aspect in the currently playing multimedia article.

2. The method of claim 1, wherein the multimedia article is one of: a movie, a television show, or a song.

3. The method of claim 1, wherein the data corresponds to at least one of: audience reaction data to the currently playing multimedia article and/or environmental data of a location in which the currently playing multimedia article is being presented.

4. The method of claim 1, wherein the receiving the data comprises receiving the data from one or more sensors associated with the computer system.

5. The method of claim 1, wherein the adjusting the least one aspect comprises adjusting at least one of: a story of the currently playing multimedia article, a script of the currently playing multimedia article, character characteristics in the currently playing multimedia article, and dialogue contained in the currently playing multimedia article.

6. The method of claim 1, wherein the adjusting the at least one aspect comprises adjusting without stopping the currently playing multimedia article.

7. The method of claim 1, wherein the identifying the audience sentiment comprises identifying a majority sentiment of an audience viewing the currently playing multimedia article.

8. The method of claim 1, wherein the identifying the audience sentiment comprises identifying a target sentiment of a subset of an audience viewing the currently playing multimedia article.

9. The method of claim 1, further comprising generating a record containing a listing of each of the adjusted at least one aspects.

10. The method of claim 9, further comprising transmitting the listing of each of the adjusted at least one aspects to a designated receiver.

11. A system comprising:
a memory including instructions; and
at least one processor configured to execute the instructions stored in the memory to perform operations comprising:
receiving data associated with a currently playing multimedia article;
identifying, based on analysis of the data, audience sentiment toward the currently playing multimedia article;
adjusting at least one aspect of the currently playing multimedia article based on the identified audience sentiment; and
presenting the adjusted at least one aspect in the currently playing multimedia article.

12. The system of claim 11, wherein the multimedia article is one of: a movie, a television show, or a song.

13. The system of claim 11, wherein the data corresponds to at least one of: audience reaction data to the currently playing multimedia article and/or environmental data of a location in which the currently playing multimedia article is being presented.

14. The system of claim 11, wherein the receiving the data comprises receiving the data from one or more sensors associated with the computer system.

15. The system of claim 11, wherein the adjusting the least one aspect comprises adjusting at least one of: a story of the currently playing multimedia article, a script of the currently playing multimedia article, character characteristics in the currently playing multimedia article, and dialogue contained in the currently playing multimedia article.

16. The system of claim 11, wherein the adjusting the at least one aspect comprises adjusting without stopping the currently playing multimedia article.

17. The system of claim 11, wherein the identifying the audience sentiment comprises identifying a majority sentiment of an audience viewing the currently playing multimedia article.

18. The system of claim 11, wherein the identifying the audience sentiment comprises identifying a target sentiment of a subset of an audience viewing the currently playing multimedia article.

19. The system of claim 11, further comprising generating a record containing a listing of each of the adjusted at least one aspects.

20. A non-transitory computer-readable medium storing computer-executable instructions which, when executed by a server in network communication with at least one database, cause the server to perform operations comprising:
receiving, at a computer system, data associated with a currently playing multimedia article;
identifying, using a processor associated with the computer system to analyze the data, audience sentiment toward the currently playing multimedia article;
adjusting, using the processor, at least one aspect of the currently playing multimedia article based on the identified audience sentiment; and
presenting the adjusted at least one aspect in the currently playing multimedia article.
